(19) United States
(12) Patent Application Publication
(10) Pub. No.: US 2006/0089840 A1
(43) Pub. Date: Apr. 27, 2006

(54) Health tracking method and apparatus

(76) Inventor: Margaret May, Belleville, IL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/970,826

(22) Filed: Oct. 21, 2004

(51) Int. Cl. G06Q 99/00

(52) U.S. Cl. 705/1

(57) ABSTRACT

A health and fitness system that maintains fitness data for members. Members can update their information in kiosks in health clubs or other locations. Members can belong to teams or departments, and progress and health goals of each team can be monitored and compared. A team which has surpassed the other teams regarding meeting health goals can be determined as the winning team.

### BACKGROUND OF THE INVENTION

1. Field of the Invention

The present invention is directed to a method, apparatus and computer readable storage to provide for an electronic way to track and maintain fitness records. More particularly, the present invention is directed to a method, apparatus, and computer readable storage for maintaining fitness records with the capabilities to cross reference them within organizations or between organizations.

2. Description of the Related Art

Prior art fitness programs can track a subject's diet, weight, etc. However, these programs are limited in their flexibility. These programs can track a user's weight loss progress and diet. However, these programs do not allow tracking of collective users.

Therefore, what is needed is an improved and more flexible way to maintain fitness and health records for collective users such as teams.

### SUMMARY OF THE INVENTION

It is an aspect of the present invention to provide an improvement in tracking health, fitness, and exercise records for parties.

The above aspects can be obtained by a method that includes (a) maintaining a plurality of teams, each team comprising a plurality of members, each member associated with fitness data; (b) updating fitness data for the members; and (c) tabulating tabulated fitness data based on the fitness data for the members of each time.

The above aspects can also be obtained by a method that includes (a) inputting from a user a targeted exercise; (b) displaying a human character; (c) highlighting parts of the human character that are relevant to the targeted exercise; (d) allowing the user to click one of the highlighted parts; and (e) displaying a list of exercises relevant to the clicked part; and upon selection, creating an exercise program based on the user's fitness level and intended sport activity if applicable.

The above aspects can also be obtained by an apparatus that includes (a) a communication unit receiving fitness data for a plurality of teams; (b) a server connected to the communication unit aggregating the received fitness data by team, computing a ranking of the plurality of teams, and making a ranking of the plurality of teams available to the plurality of teams.

The above aspects can also be obtained by a computer readable storage medium storing a method to maintain fitness information, the storage medium controlling a computer by (a) maintaining a plurality of teams, each team comprising a plurality of members; (b) updating fitness data for the members; and (c) tabulating tabulated fitness data based on the fitness data for the members of each time.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating an organization and their relations, according to an embodiment;

FIG. 2 is a block diagram illustrating a link health system network, according to an embodiment;

FIG. 3 is a flowchart illustrating an example of a method to maintain user data, according to an embodiment;

FIG. 4 is a flowchart illustrating an example of a method to tabulate and record data, according to an embodiment;

FIG. 5 is an example of a screen output illustrated different departments and their respective scores, according to an embodiment;

FIG. 6 is a flowchart illustrating a method of determining team standings, according to an embodiment;

FIG. 7 is flowchart illustrating a method of computing bonus points, according to an embodiment;

FIG. 8 is an example of a display illustrating a querying of user information, according to an embodiment;

FIG. 9 is an example of a display illustrating a presenting and selecting exercises, according to an embodiment;

FIG. 10 is an example of a display illustrating a suggesting of exercises, according to an embodiment;

FIG. 11 is an example of a display illustrating a method to select exercises, according to an embodiment;

FIG. 12 is an example of a display illustrating fields entered into a profile, according to an embodiment;

FIG. 13 is an example of a display illustrating setting fitness goals, according to an embodiment;

FIG. 14 is an example of a display illustrating a setting of health challenge goals, according to an embodiment;

FIG. 15 is an example of a display illustrating a status of an individuals progress, according to an embodiment;

FIG. 16 is an example of a display illustrating a status of a team's progress, according to an embodiment;

FIG. 17 is an example of a display illustrating a result recording screen, according to an embodiment;

FIG. 18 is an example of a display illustrating progress of a plurality of teams, according to an embodiment;

FIG. 19 is an example of a display allowing a user to select a desired display, according to an embodiment; and

FIG. 20 is an example of a display allowing a party to enter a company profile, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention provides for an apparatus and method to maintain health and fitness information. The health and fitness information can be maintained for participants that are employed with organizations (such as companies, government agencies, etc.) or are members of health and fitness clubs. Each organization may comprise different departments (e.g. an accounting department, an IT department, etc.). A participant may be associated with an organization, and may be associated with one or more departments within that organization.

Information regarding the members of an organization, and members of a department or departments of a respective organization, can be tabulated and displayed for easy comparison of information between organizations (and departments).

As one example of the present invention, people who work for the accounting department in company A can enter their fitness information into a database. Whenever a person in the accounting department performs exercises or undergoes any change in health status, the person can update a database (using a remove computer or kiosk connected to a server via a computer communications network such as the Internet) with the new information. A company can tabulate and view people's information who work in different departments. For example, the average weight of the IT department can be compared with the average weight of the vice presidents. Any data that the system can store and maintain can be tabulated and outputted accordingly. The data output may be limited to aggregate data in order to comply with standards regarding privacy of individual data.

Participants can also set goals for themselves such as weight loss goals. The invention also allows companies (or departments with companies) to orchestrate a challenge wherein scores for selected categories can be compared, and a “winner” or higher ranked company or team can be determined. For example, company A may challenge company B as to which company can lose the most average pounds by a certain date. For example, departments of a company can be ranked by which department exercises the most.

A further benefit of the present invention is that it can encourage employees of a company to stay healthy or become healthier. This can have indirect benefits to the company, such as reducing their health care and life insurance costs. Thus, by monitoring their employees, a company can help to promote a healthy environment which is a win/win situation for everyone. The present invention can accomplish this in a fun and entertaining manner, which encourages the employees to participate.

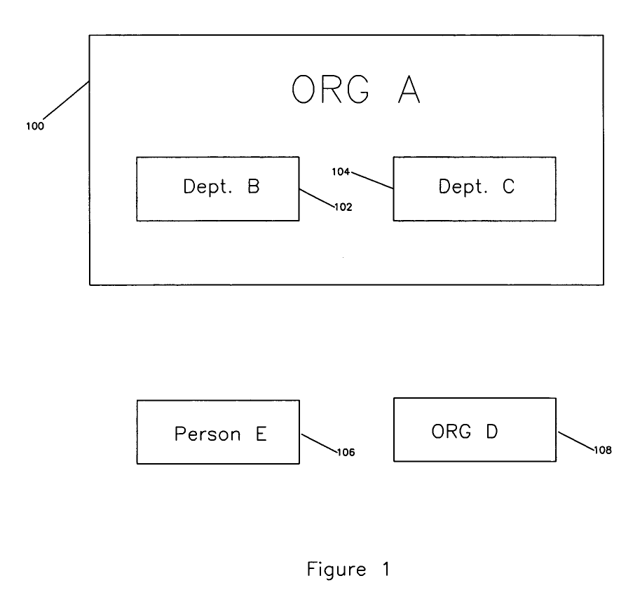

FIG. 1 is a block diagram illustrating an organization and their relations, according to an embodiment.

Organization A comprises 100 department B 102 and department C 104. Person E 106 exists solely. Organization D 108 is another organization. All of parties illustrated herein can utilize the present system and be tabulated (or compared) against one another.

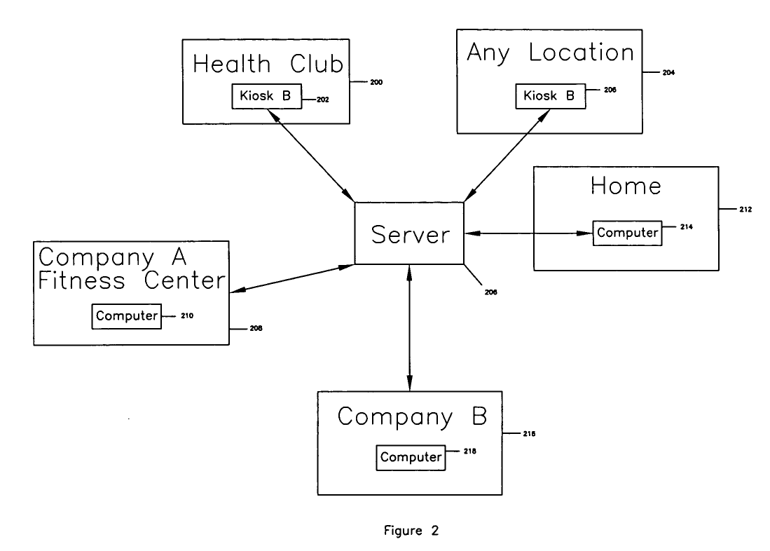

FIG. 2 is a block diagram illustrating a linked health system network, according to an embodiment.

A server 208 is connected via a computer communications network (such as the Internet) to a health club 200. The server can be running an application which uses a database such as an SQL or any other database application including a custom database application

The health club 200 can have kiosk B 202 in it which allows a user to interact with the server 206 and utilize the methods described herein. The sever 208 also can be linked to kiosk B 206 which can be located at any location 204 (e.g. a store, a shopping mall, etc.) Company A can have a fitness center 208 which has a computer 210 (or kiosk, etc.). The computer 210 also allows a user to interact with the server 206. A home 212 of a user can also have a computer 214 which allows the user to interact with the sever 208 and use the methods described herein via a computer communications network. The server 208 can also be linked to company B 216 which has a computer 218 somewhere on premises which allows a user to interact with the server 208. It is also noted that while only one server 206 is illustrated herein, multiple linked servers (not pictured) can also be used to implement the present invention.

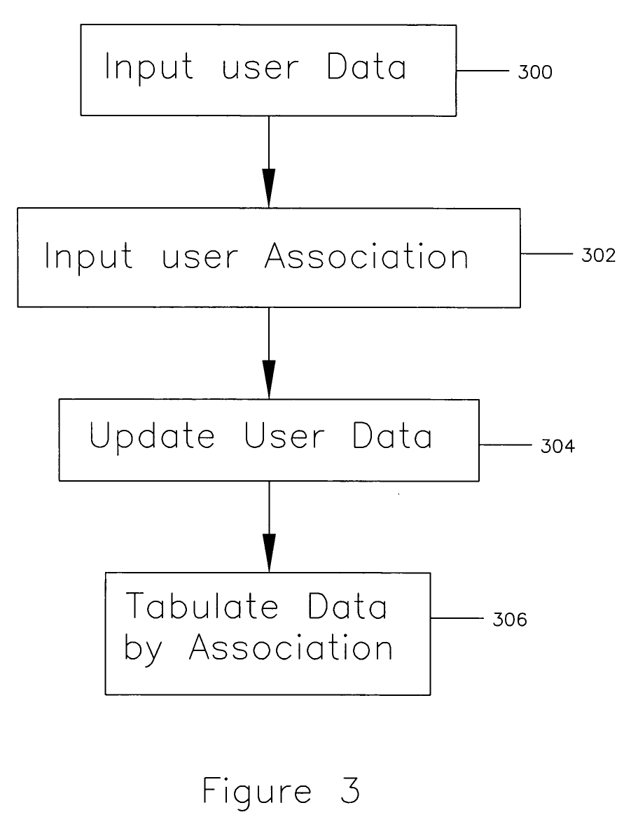

FIG. 3 is a flowchart illustrating an example of a method to maintain user data, according to an embodiment.

The method begins with operation 300, which inputs user data. The user data can be any personal information about the user, such as name, age, weight, etc. Details of this operation will be discussed below in more detail. The inputting can be accomplished using any input/output system as known in the art.

The method proceeds to operation 302, which inputs user association(s). An association can be a company name, and/or a department within the company, a social group (e.g. a fraternity or sorority) or any collective entity. Having an association associated with the user allows data from the associations to be tabulated and viewed at a later time.

From operation 302, the method proceeds to operation 304, which updates user data. Users can update their information from any remote terminal(s) as described in FIG. 2. For example, a user can be working out at a health club and performs a number of a particular exercise. The user can enter the number of the particular exercise the user performed into a computer or kiosk which can record the information in a record associated with the user. Data can then be updated in a database system (e.g. a SQL-based system).

From operation 304, the method proceeds to operation 306, which tabulates the data by association. For example, information for each department within a company can be tabulated, viewed, and compared. Thus, management of a company can determine which departments within an organization are the most and least healthy, which can possibly be used for management purposes. Any data associated with a user record can be tabulated by the user's associated group (e.g. a department or his or her company) and compared with other groups. This can be accomplished, for example, using a Database package (e.g. available from Oracle, etc.).

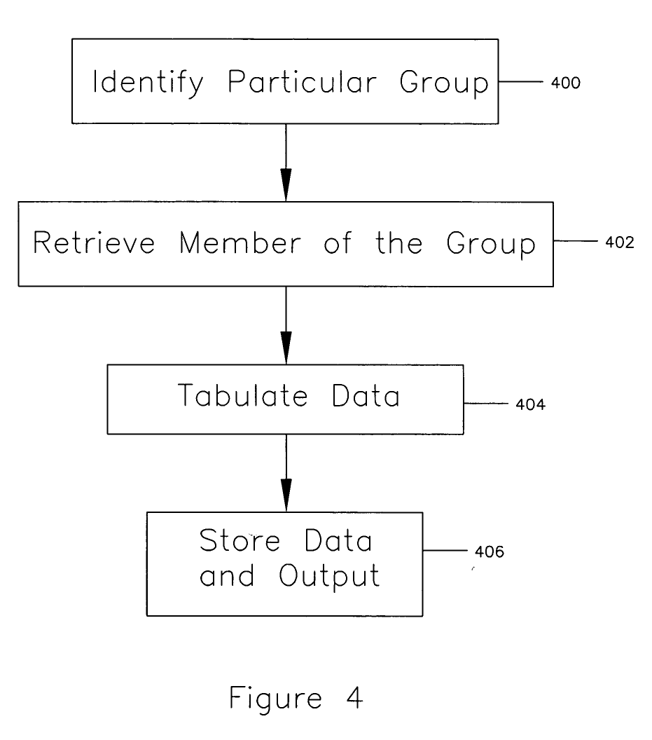

FIG. 4 is a flowchart illustrating an example of a method to tabulate and record data, according to an embodiment.

The method starts with operation 400, which identifies a particular group. An operator can identify a particular group, such as the IT department at his or her company. The identification of a group can also be performed automatically, such as by a computer that is tabulating data automatically.

From operation 400, the method proceeds to operation 402, which retrieves members of the group identified in operation 400. This can be accomplished using any database system.

From operation 402, the method then proceeds to operation 404, which tabulates the relevant data for that group. This can be accomplished using any database system.

From operation 404, the method proceeds to operation 406, which stores the data and can output it, for example to a CRT display. This can be accomplished using any database system.

Tabulated data can be output to a CRT (or other output device) so that a user can review the data. Tabulated data can also be made on the internet A sever (such as server 206) can output all (or some) team data (e.g. team standings, points earned, etc.) to members of the teams.

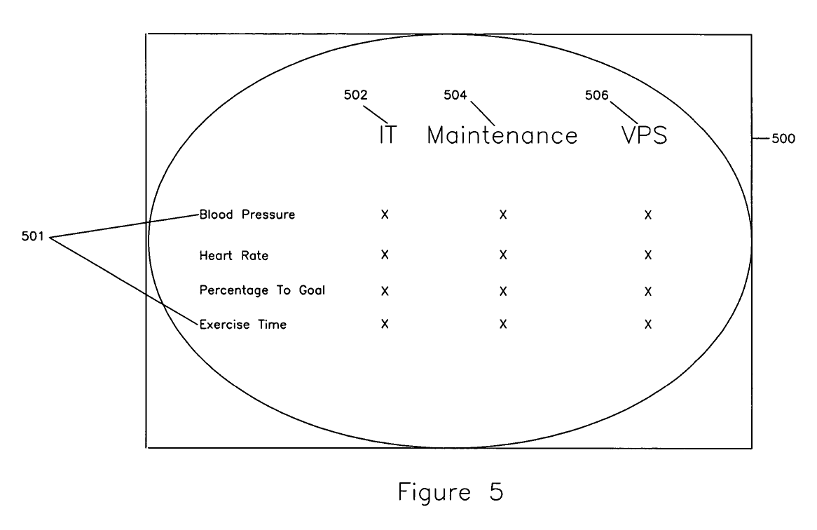

FIG. 5 is an example of a screen output illustrated different departments and their respective scores, according to an embodiment.

An output device 500 outputs tabulated data. The tabulated data can comprise a characteristic list 501 which comprises any characteristics the system can store or compute. The characteristic list has respective departments (or companies, organizations, etc.) which display tabulated data for that department. In the example illustrated in FIG. 5, the blood pressure, heat rate, percentage to goal, and exercise time, can be viewed for the IT, maintenance, and VP's. In this way, the company management can view the data and determine which parties may be deficient in certain health aspects.

Different departments or organizations can also be subject to a challenge or comparison. For example, company A can undergo a challenge against company B. For example, each company can set as the winning criteria the number of total pounds lost. Thus, all of the pounds lost by company A can be compared by the pounds lost by company B after a certain time.

Data from the different teams can be ranked and sorted in an order relevant to the team's accomplishments. For example, each team can be tabulated and ranked by the team's total bonus points (which would be the sum of the bonus points of each member of the respective team). Alternatively, teams can be tabulated and ranked by any criteria, such as percentage to goal (or the average of all members' percentages to goal), weight loss, or any variable described herein or known in the art.

When teams are ranked, members can sign online to view the team standings. The team standings can be made available on a public web site, or a private web site may be used which requires a user login and password.

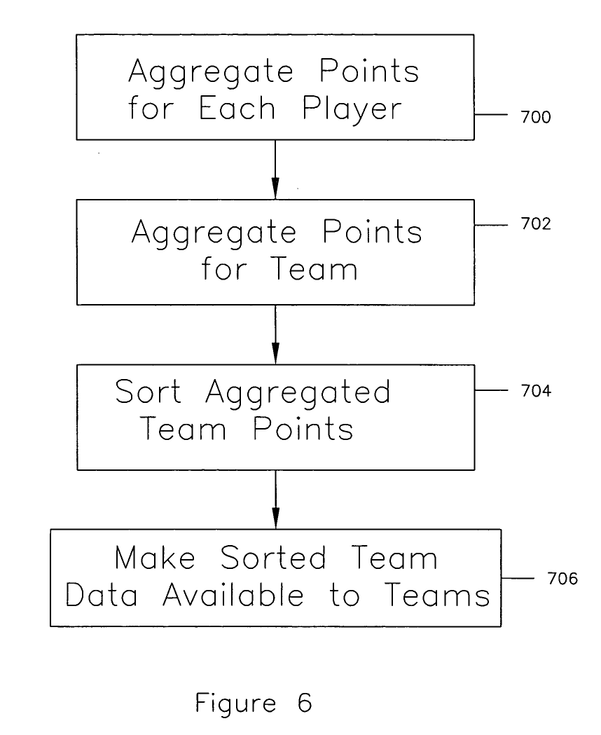

FIG. 6 is a flowchart illustrating a method of determining team standings, according to an embodiment.

In operation 600, points are aggregated for each player. Points (e.g. bonus points or any other type of points or measure) can be added from individual goals, or any other predetermined criteria.

From operation 600, the method proceeds to operation 602, which aggregates the points for each team by aggregating the points for each player.

From operation 602, the method proceeds to operation 604 which sorts the aggregated team data by points. Thus, the team in the lead would typically have the most points. Alternatively, teams can be ranked with the team with the least points first, if the points measure an undesirable quality, e.g. weight, such team the team ranked first weighs the least.

From operation 604, the method proceeds to operation 606, which makes the data computed in operation 604 available to other parties.

As described herein, bonus points can be awarded based on a member of a team's achievements. Bonus points should ideally take into consideration both the progress the member has made as well as the difficulty of the goals set. For example, if a person originally weighs 125 lbs and has a goal to weigh 115 lbs, and currently weighs 120 lbs, then the person has achieved a 50% to goal. However, a person that originally weighed 250 and has a goal to weigh 150 currently weighs 200, then this person also has achieved a 50% to goal. Of course, the latter person should earn more bonus points because of the greater difficulty this person must have gone through to lose the 50 lbs.

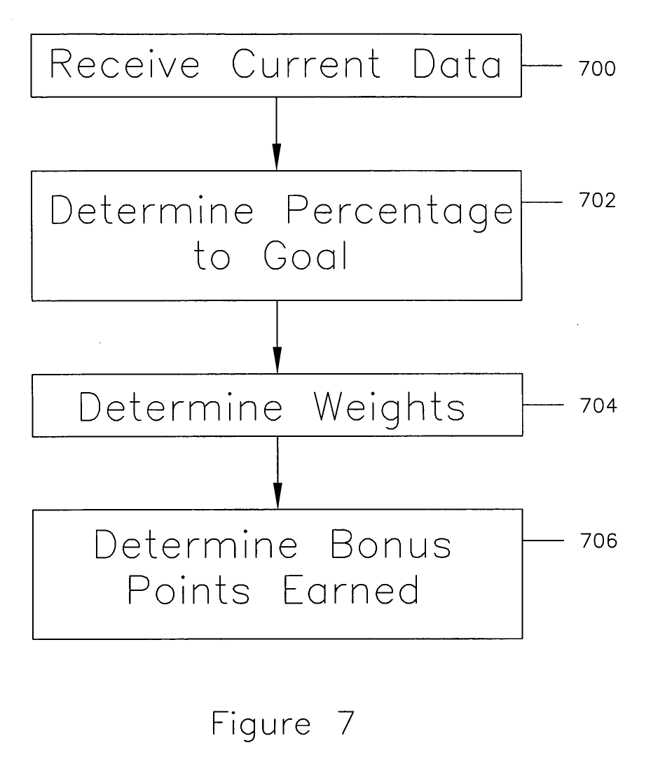

FIG. 7 is flowchart illustrating a method of computing bonus points, according to an embodiment. This is not the only method, and of course it can be appreciated that other methods can be performed which accomplish the same goal.

The method starts in operation 700, which receives current data. The current data can comprise goals, current values, starting values, etc. The goals can be selected by the user or given to the user based on data the user has input (e.g. his current weight).

The method then proceeds to operation 702, which can determine the percentage to goal. This can be the percentage of the way the member has made it to achieving his or her goal. For example, if a beginning weight is a and a goal weight is b and a current weight is c, then the percentage to goal would be (c−b)/(a−b). In some cases a value is more desirable to increase (e.g. muscle mass) although the same or similar formula can be used.

The method can proceed to operation 704, which determines weights. For example, the weights of relative goals can be determined. This can be done by using formulas, look up tables, tables of ranges, etc. For example, a table can be used wherein a member who has a goal weight loss of 10 lbs or less has a weight of 1, a weight loss of 10-15 lbs has a weight of 2, a weight loss of 15-20 has a weight of 3, etc. The weights of the goals can be used as described above to normalize goals which may have different difficulties.

The method can proceed to operation 706, which can determine the bonus points earned. This can be determined using the percentage to goal computed in operation 702 as well as the weight of goals determined in operation 704. The bonus points can be computed, for example, by multiplying the percentage to goal by the weight by a constant. Using a constant equal to 0.1, then we can use the above example again.

For example, consider the person that weighs 125 lbs and has a goal to weigh 115 lbs, and currently weighs 120 lbs, then the person has achieved a 50% to goal. Using the above weights, the weight of the goal would be 1. Thus, the amount of bonus points earned would be 50*1*0.1=5. Now consider the person that originally weighed 250 and has a goal to weigh 150 currently weighs 200, and has also achieved a 50% to goal. The weight of this weight loss goal (50 lbs) can be 9. Thus, 50*9*0.1=45. Thus, this person has earned 45 bonus points.

It is noted the above examples are merely examples of computing bonus points and many other methods can be used, using formulas, tables, a combination of both, etc. Further, the computation can be performed in any order. The basic principle is to award more points to a party that has worked harder. Any other weight structure, constants, formulas, etc., can be used.

It is further noted that privacy may be an issue with some users. Some users may not wish their personal data viewed by others. The team standings can be displayed by the server to members of the tams. Thus, permission preferences can be set by each user. A user can decide not to allow any (or some) of his or her personal information to viewed by anyone or tabulated in the team's tabulated data. A user can also decide not to allow any (or some) of his or her personal information to be viewed by others, but will allow his or her data to be tabulated in the team standings. A user can also decide not to allow his or her data to be viewed or tabulated in the team standings.

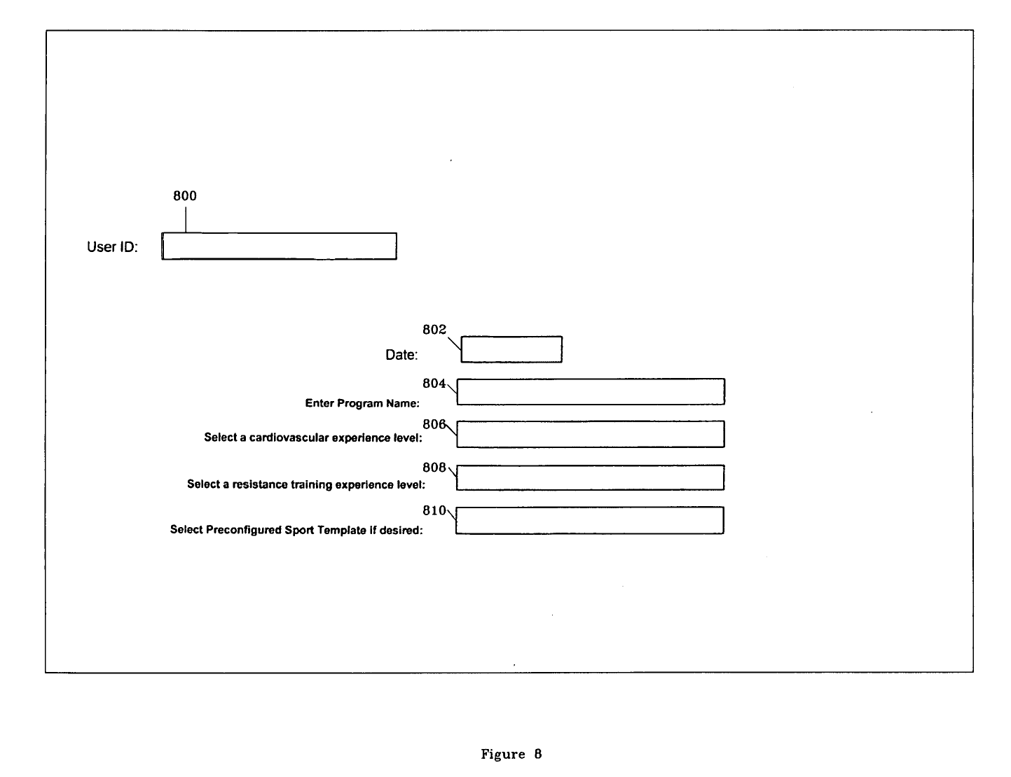

FIG. 8 is an example of a display illustrating a querying of user information, according to an embodiment.

A user can input his or her user ID 800. The user ID can be the user's name or a selected moniker to use with the system. The date 802 can be displayed automatically or can be inputted by the user. The user can also input a program name 804 which identifies a particular exercise program the user wishes to begin. The user can also input a cardiovascular experience level 806 (or any type of experience level) which identifies the user's particular respective experience level. The user can also input a resistance training experience level 808 which identifies the user's particular respective experience level. The user can also input a preconfigured sport template 810 which identifies a particular sport with which the user wishes to target his or her exercises. Any of the fields indicated in FIG. 8 (with the exception of the user ID 800) can be optional, either in the system itself or entered by the user.

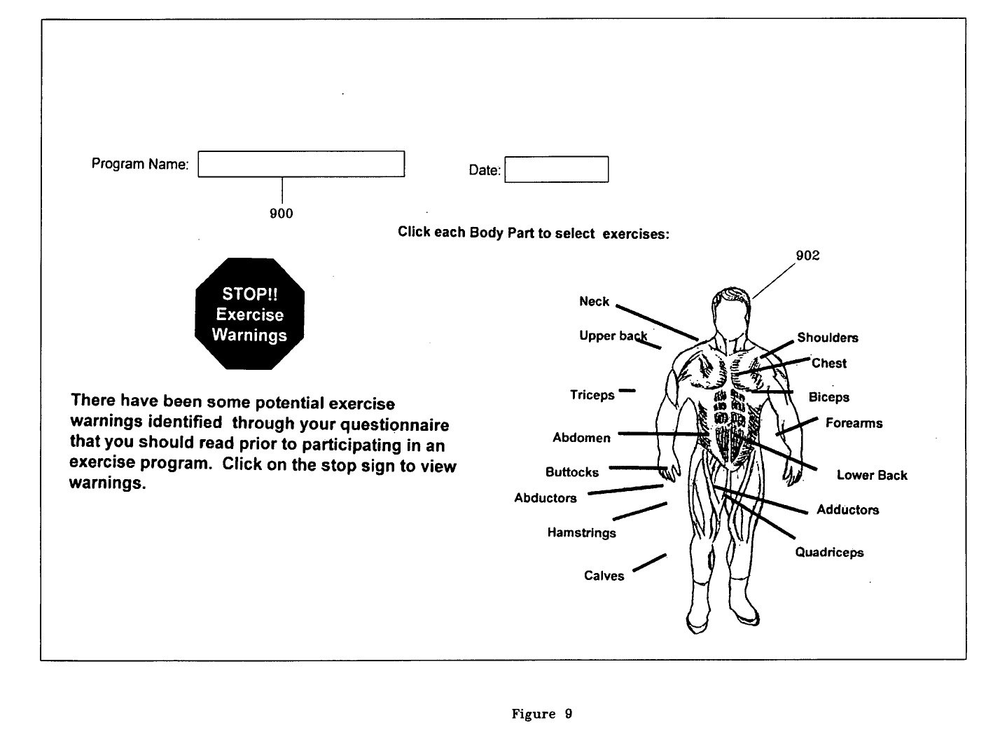

FIG. 9 is an example of a display illustrating a presenting and selecting exercises, according to an embodiment.

A program name 900 can be entered by the user or automatically displayed by the system which displays a current program which is being used by the user. A human character 902 illustrates different muscles that can be exercised. The user can click on muscles or body parts on the character 902 which will trigger display of exercise(s) for that muscle.

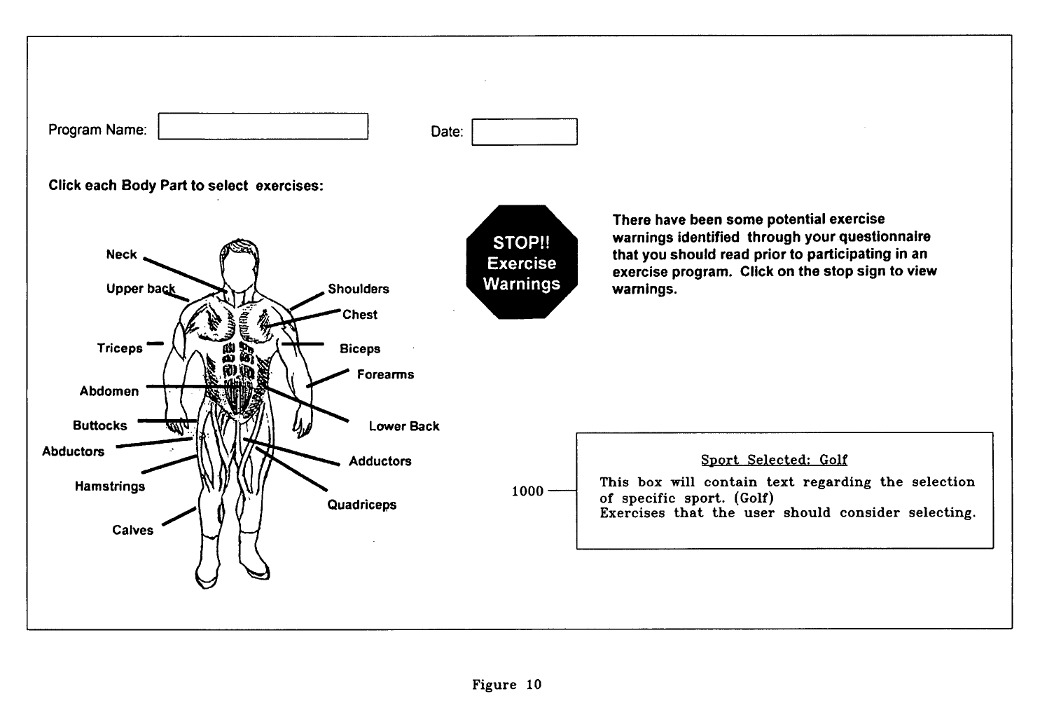

FIG. 10 is an example of a display illustrating a suggesting of exercises, according to an embodiment.

If the user indicates that he or she is targeting exercises to a particular sport (for example by entering a sport into the preconfigured sport template 810), then a targeted screen can be displayed which targets the screen to the respective particular sport. A targeted exercise window can display text or graphics relating to exercises targeted to the specific sport (e.g. golf). In an embodiment of the present invention, if the user has indicated a targeted sport, then typically exercises sited for the particular targeted sport and for specific muscles or body parts relevant to that sport are initially displayed for selection. For example, if the sport selected is tennis and the buttocks is not really relevant to tennis, the user will be able to select buttocks but the window of selectable exercises would be empty. If the user wants the ability to select exercises for the buttocks regardless, there will be a button that may be clicked to display all exercises pertaining to the buttocks for selection. In the case that the user wants to have the ability of selecting from the entire list of exercises for a specific muscle or body part, beyond those displayed that are only specific to the selected sport, the user may click on the button to display all exercises for the specific muscle or body part.

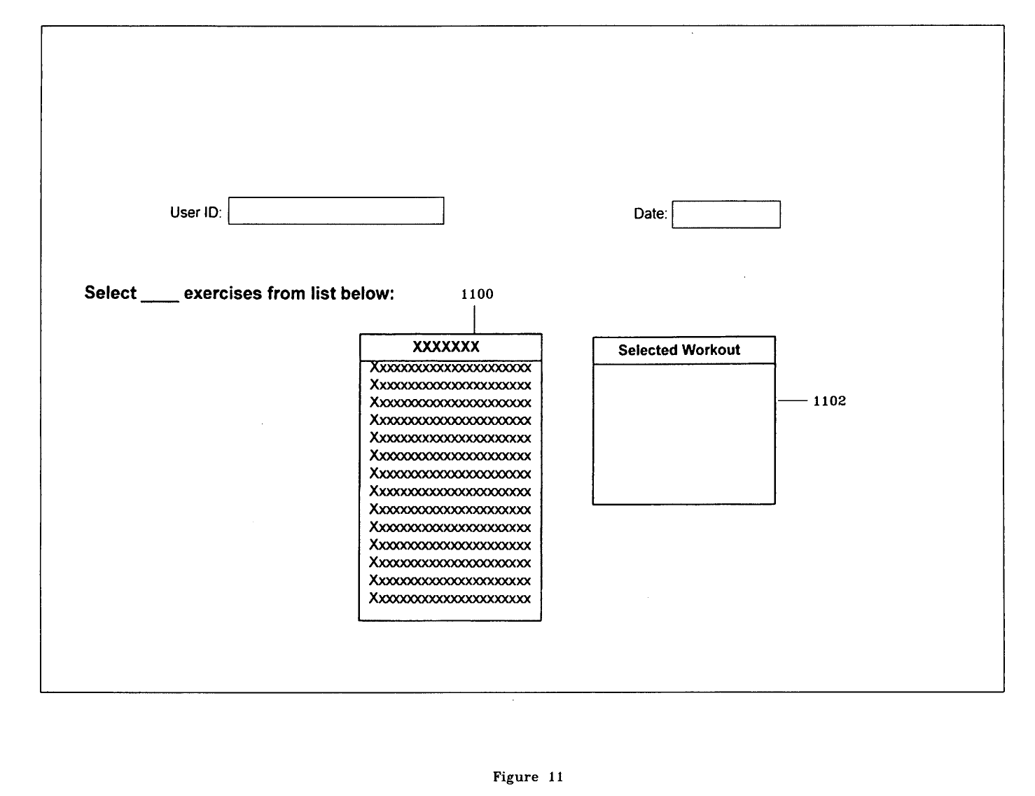

FIG. 11 is an example of a display illustrating a method to select exercises, according to an embodiment.

An exercise list 1100 can be displayed for a particular muscle or body part selected as discussed with regard to the previous figures. A selected workout 1102 can be displayed which displays exercises selected by the user from the exercise list 1100.

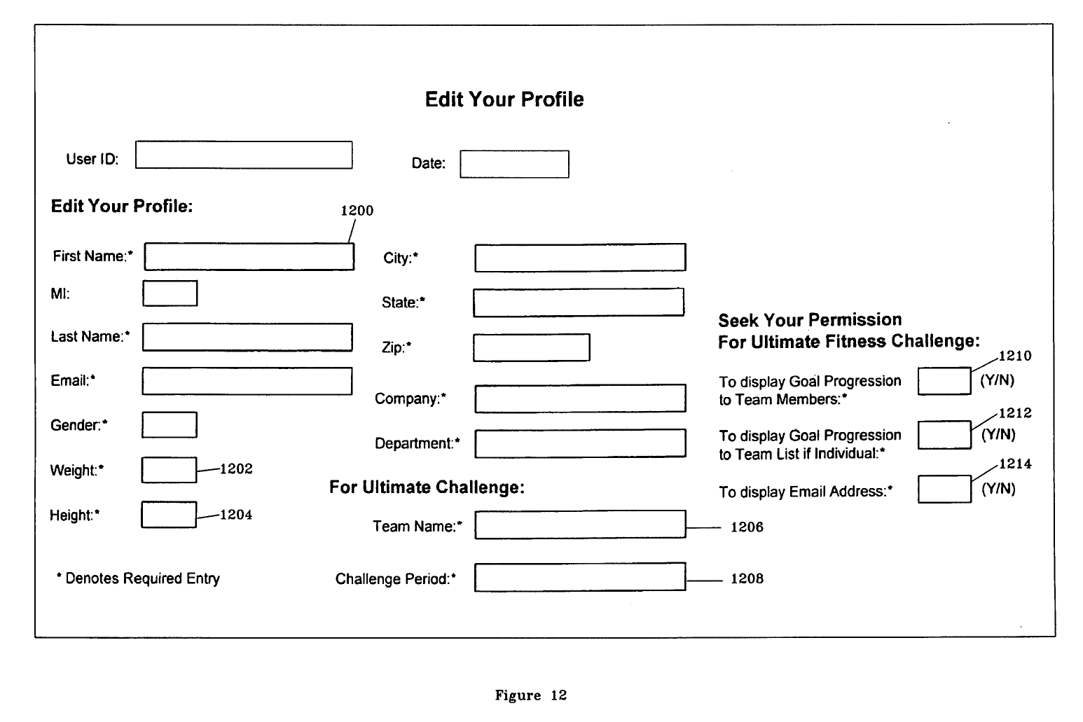

FIG. 12 is an example of a display illustrating fields entered into a profile, according to an embodiment.

A first name field 1200 is for the user's first name. Other fields can be entered similarly.

A team name 1206 can identify a name of a team that the user is on. A challenge period 1208 can identify a period in time that a fitness challenge will take place (e.g. until the challenge is over).

A user may or may not wish to give permission for others to view their data. Thus, a permission to display goal progression to team members field 1210 can input whether or not the user wishes to grant permission to display the user's goal progression to other team members. A permission to display goal progression to team list if individual field 1212 can input whether or not the user grants permission to display the user's goal progression to the aggregate team tabulations. A permission to display email address field 1214 can input whether or not the user wishes that his or her email be displayed to other members.

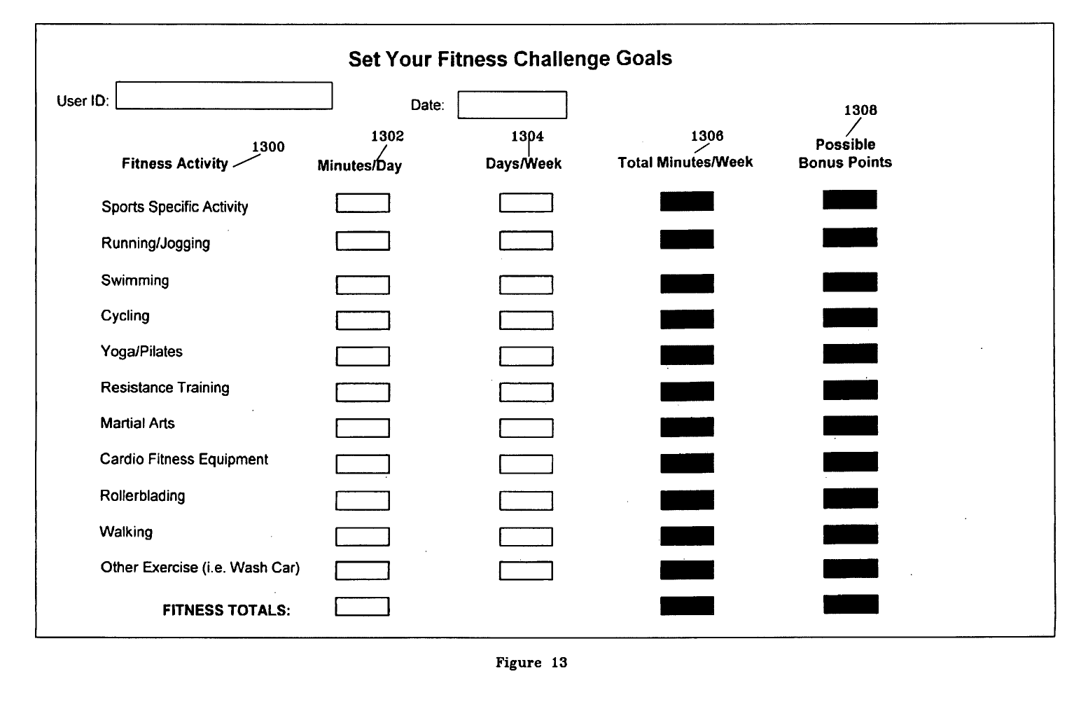

FIG. 13 is an example of a display illustrating setting fitness goals, according to an embodiment.

A user can set his or her own personal fitness goals which can be stored in the system. As the user exercises, loses weight, etc., this data can be entered into the system so that the user can track his or her progress.

A fitness activity list 1300 is a list of particular activities that the user may have selected as part of their fitness plan. A minutes/day field 1302 indicates how many minutes per day the respective exercise has been performed. A days/week field 1304 indicates how many days per week the respective exercise has been performed. A minutes/week field 1306 indicates how many minutes per week the exercised has been performed. A possible bonus points field 1308 indicates how many bonus points the user has earned. Bonus points can be earned based on the user matching or exceeding his or her goals.

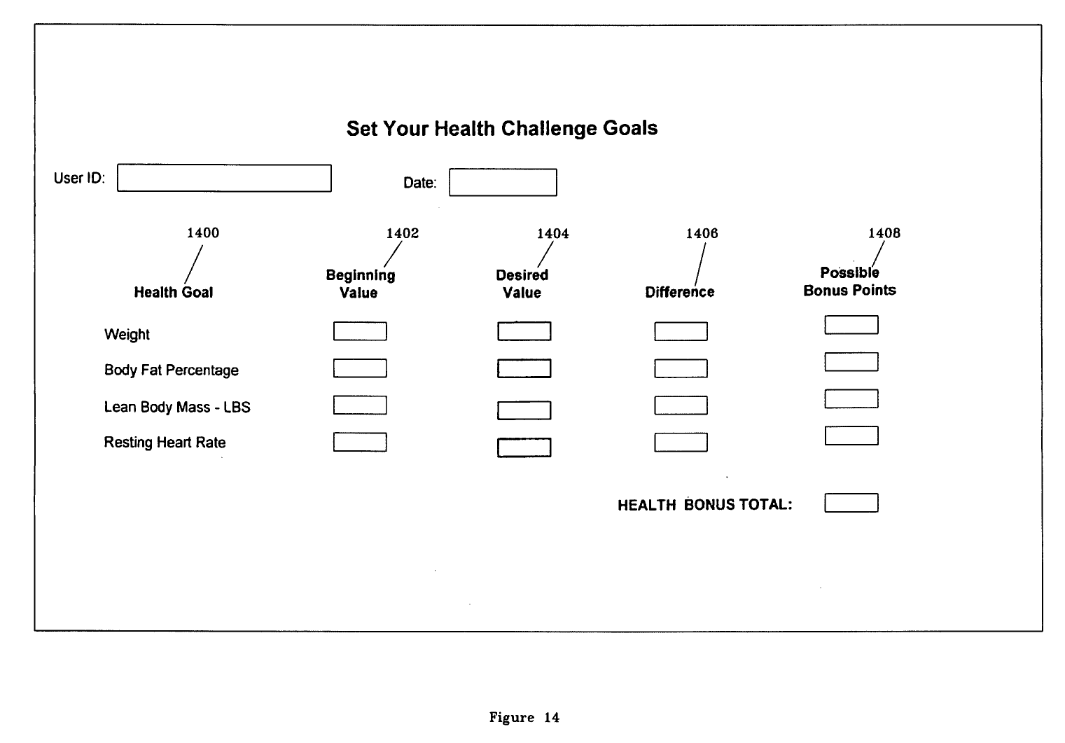

FIG. 14 is an example of a display illustrating a setting of health challenge goals, according to an embodiment.

A health goal list 1400 lists selected (or mandated) health goals for the user. A beginning value 1402 indicates values for respective health goals when the user has begun using the system (or has begun a fitness challenge). A desired value list 1404 indicates values for the respective health goals that the user wishes to attain. A difference list 1406 indicates a difference between the desired value and the beginning value. A possible bonus points list 1408 indicates how many possible bonus points that are available to the user. Bonus points can be awarded if the user exceeds his or her goals.

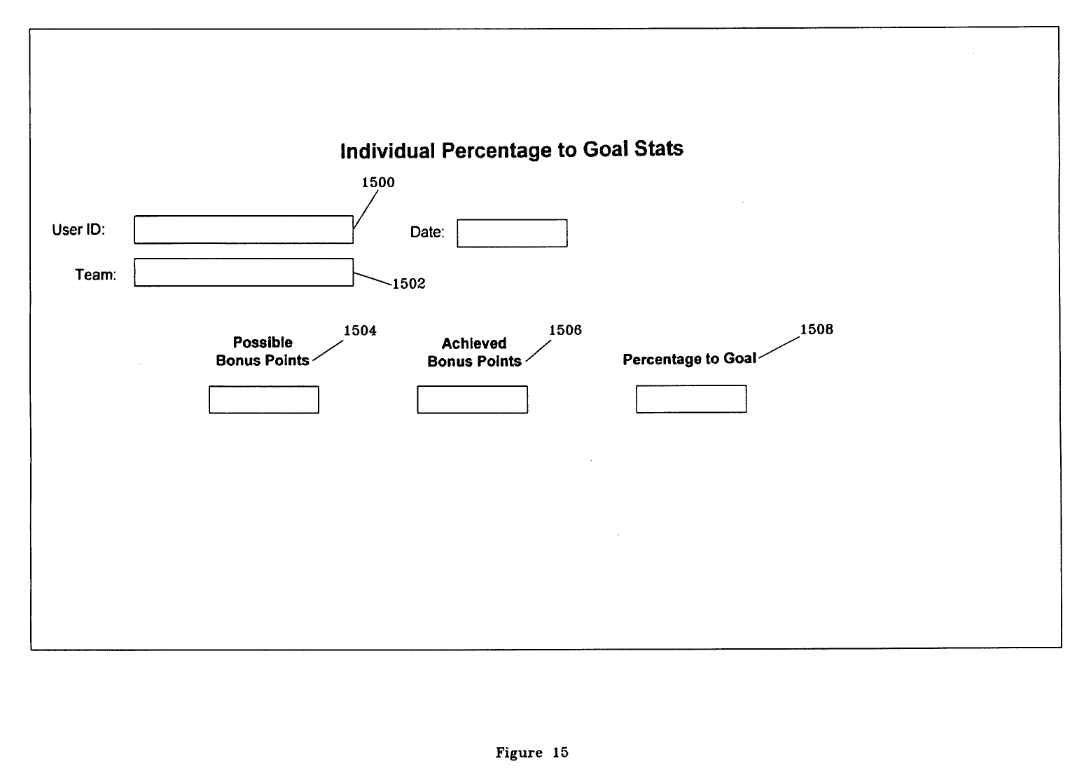

FIG. 15 is an example of a display illustrating a status of an individuals progress, according to an embodiment.

A user can view his or her individual percentage to goal statistics. This can include the user ID 1500 and his or her associated team 1502. The team 1502 can also be the user's company, department, etc. A possible bonus points 1504 field indicates a possible number of bonus points that can be earned. An achieved bonus points field 1506 indicates an already earned number of bonus points. A percentage to goal field 1508 indicates a percentage to the user's goal the user has attained. For example, if the user begins with a weight of 200, and sets a goal weight of 100 lbs, and currently weights 150 lbs, then the user has attainted 50% of his percentage to goal.

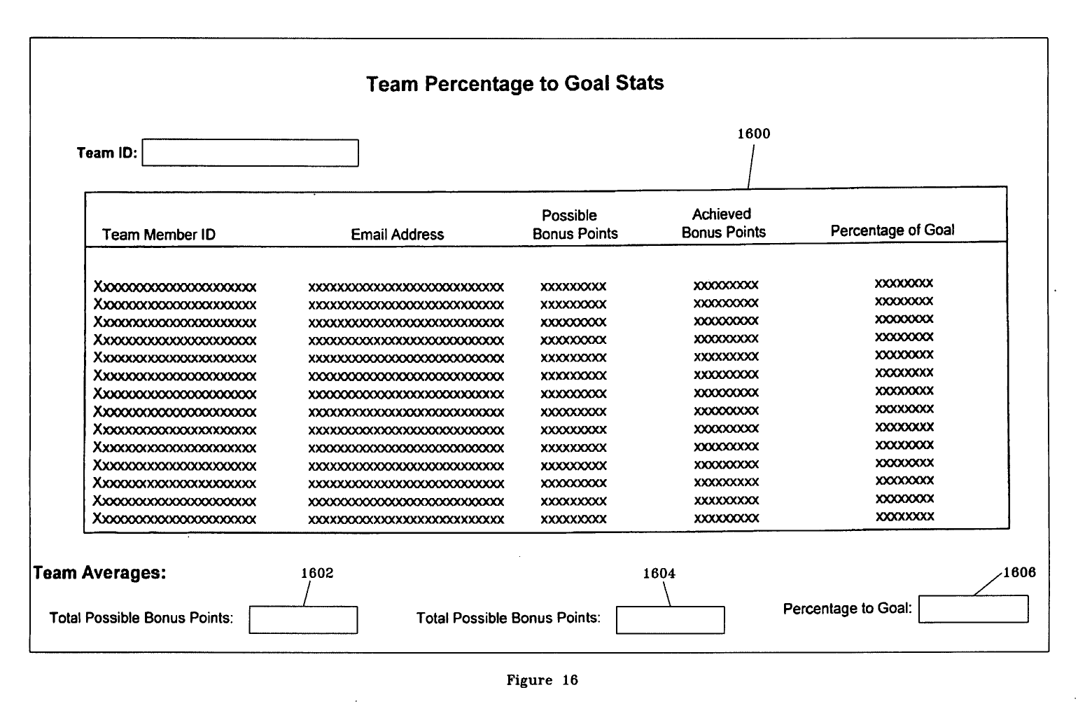

FIG. 16 is an example of a display illustrating a status of a team's progress, according to an embodiment.

A team list 1600 displays team members, possible bonus points each respective team member can earn, achieved bonus points for the respective team member, and a respective percentage of goal.

A total possible bonus points field 1602 for the team is displayed. A total achieved onus points field 1604 for the team is displayed. A percentage to goal field 1606 for the team is displayed.

When a user exercises, loses (or perhaps gains) weight, or undergoes any other change reflecting any of the characteristics that the system collects, then the user can update his or her user data (as described in operation 304). This can be done at a computer or kiosk terminal using a result recording screen.

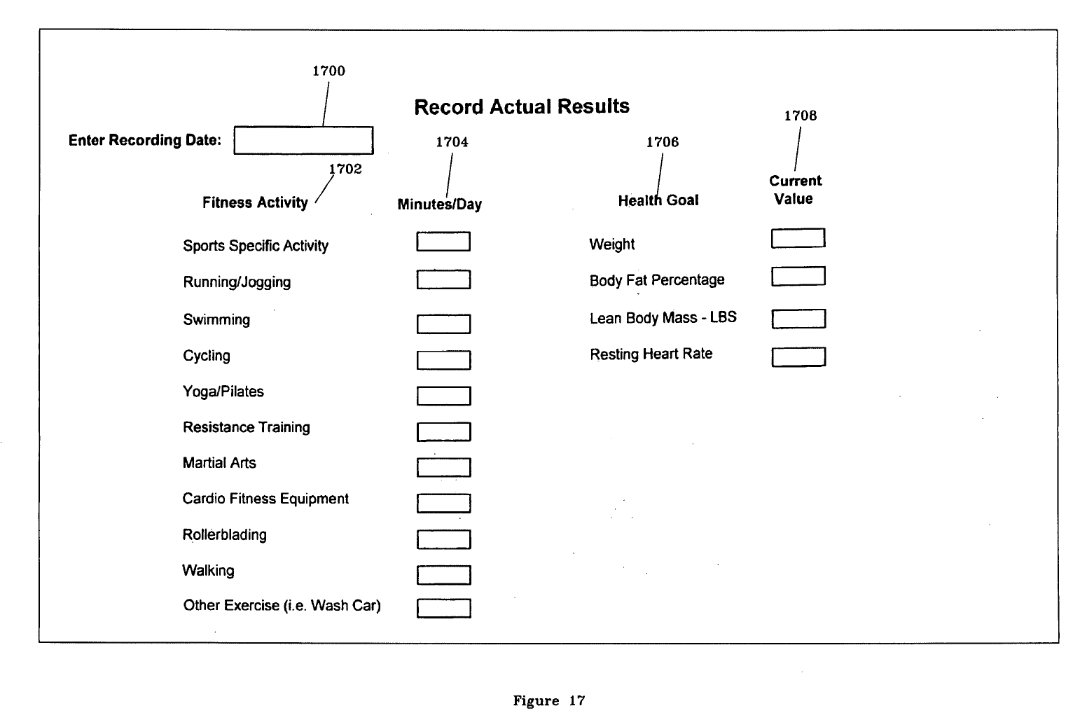

FIG. 17 is an example of a display illustrating a result recording screen, according to an embodiment. The user can enter the current date in a date field 1700, or this field can be automatically filled in by the system. A fitness activity list 1702 displays particular fitness activities. A minutes/day list 1704 allows the user to indicate how many minutes for that day the user has performed each respective fitness activity.

A health goal list 1706 lists health goals. A current value list 1708 lists values for each respective health goal.

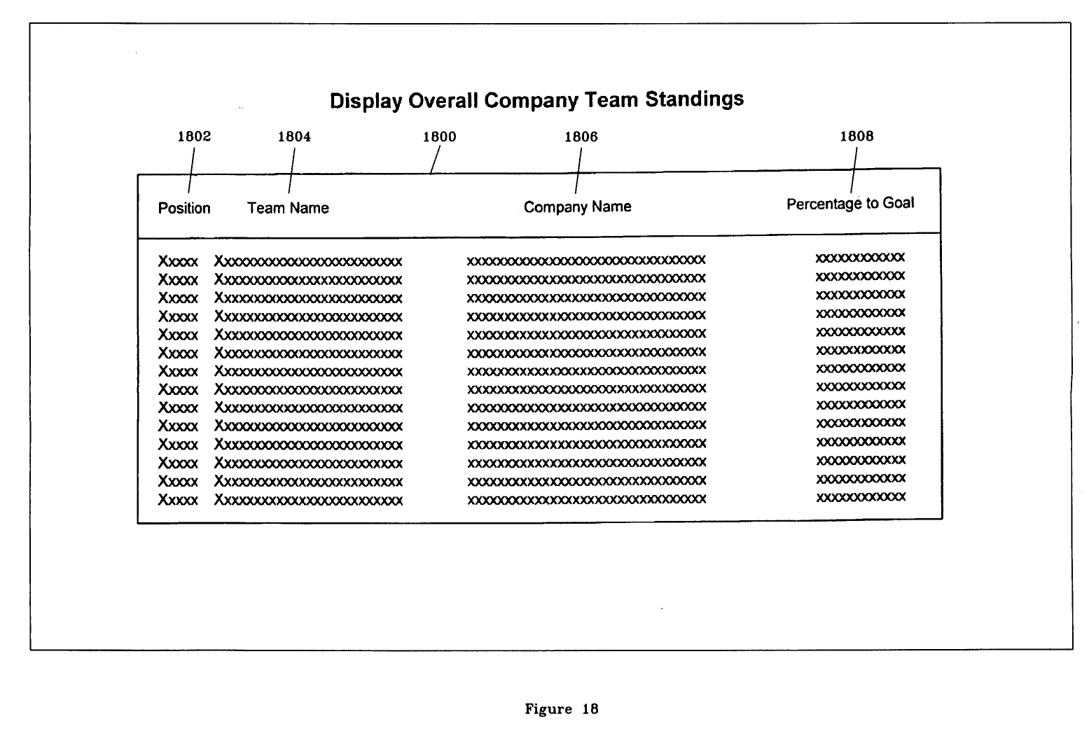

FIG. 18 is an example of a display illustrating progress of a plurality of teams, according to an embodiment.

Data for the teams in the system can be compared to one another and can also be ranked in team comparison display 1800.

A position list 1802 is a list of numbers (typically 1, 2, 3,) indicated a position of a respective team. A team name list 1804 lists a list of participating teams. A company name list 1806 is a list of company names for respective teams. A company may be a team in itself, or a company may comprise a plurality of teams. A percentage to goal list 1808 is a list of respective percentage to goal values for each respective team.

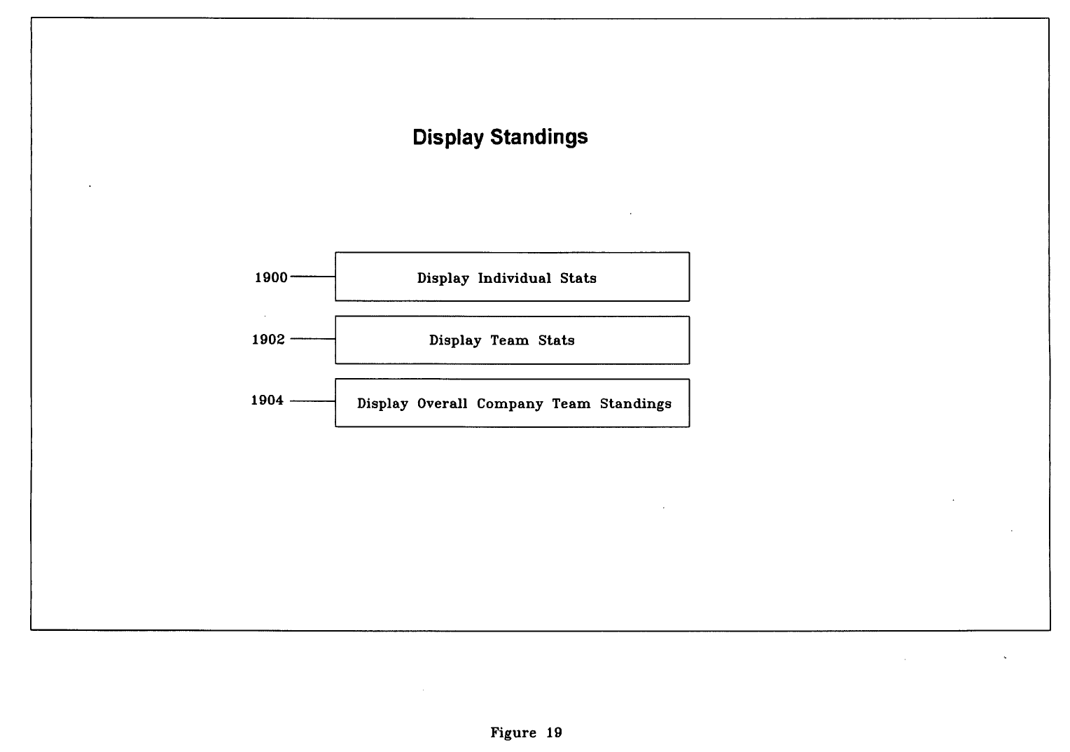

FIG. 19 is an example of a display allowing a user to select a desired display, according to an embodiment.

A user can perform many operations on a computer which can be directly implementing or linked to a machine which implements the methods described herein. A user can select a number of buttons which can perform various operations.

A display individual stats button 1900 allows a user to view a particular individual's statistics. If the particular individual has not given permission to allow the user to view his or her statistics, then the user will not be allowed to view them. A display team stats button 1902 allows a user to view a team list 1600 or related output which outputs statistics for different teams. A display overall company team standings button 1904 allows a user to view overall team standings such as the team comparison display 1800.

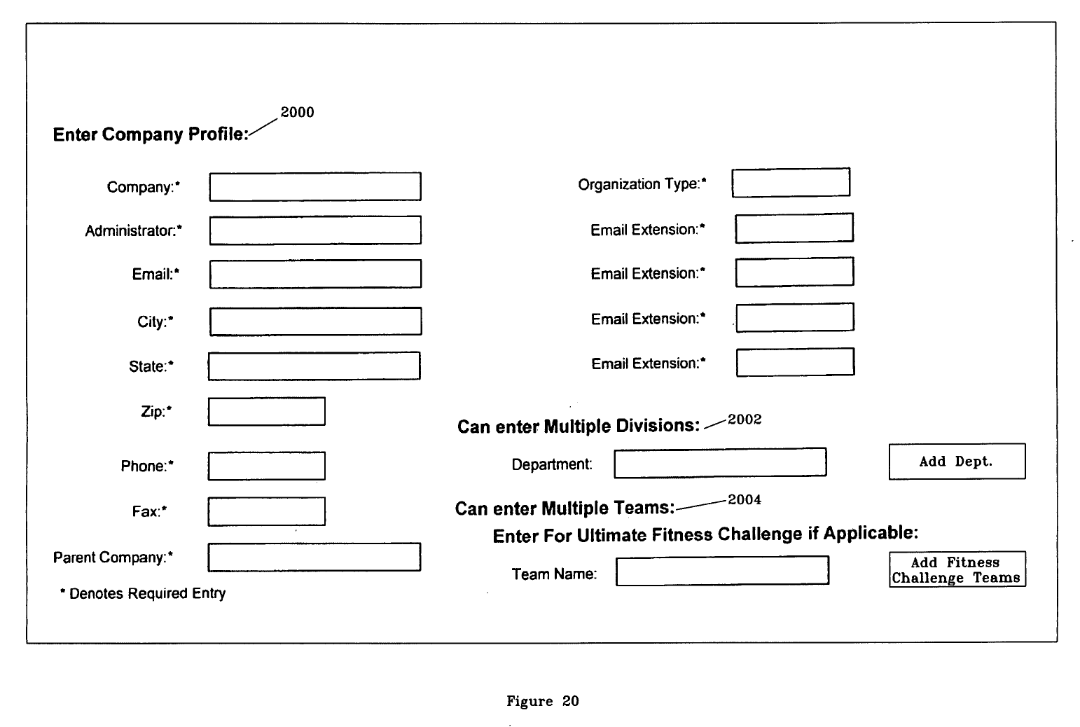

FIG. 20 is an example of a display allowing a party to enter a company profile, according to an embodiment.

A company (or team) should enter their own information into the database. A company profile 2000 allows a team leader to enter this information.

A company can have departments which can be entered into a department field 2002. A plurality of departments can be entered for each company. Each team can have a team name entered into a team name field 2004.

It is also noted that any and/or all of the above embodiments, configurations, variations of the present invention described above can mixed and matched and used in any combination with one another. Any claim herein can be combined with any others (unless the results are nonsensical).

The present invention includes any software and/or hardware needed to implement the present invention which can include, for example, database packages based on Oracle, etc. Programs for implementing the present invention can also be stored on a computer readable storage medium such as a CD-ROM, etc., Moreover, any description of a component or embodiment herein also includes hardware, software, and configurations which already exist in the prior art and may be necessary to the operation of such component(s) or embodiment(s).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to maintain fitness information, the method comprising:
maintaining a plurality of teams, each team comprising a plurality of members, each member associated with fitness data;
updating fitness data for the members; and
tabulating tabulated team fitness data based on the fitness data for the members of each team.

2. A method as recited in claim 1, further comprising setting a fitness goal for a member of a team for an individual health characteristic.

3. A method as recited in claim 2, further comprising determining an amount of bonus points for the member based on a measure of goal completion for the goal.

4. A method as recited in claim 3, wherein the bonus points are equalized so that more difficult fitness goals earn more bonus points.

5. A method as recited in claim 3, further comprising aggregating bonus points for a plurality of characteristics for the member.

6. A method as recited in claim 3, aggregating bonus points for members of a team.

7. A method as recited in claim 6, further comprising ranking teams based on respective aggregated levels of bonus points earned.

8. A method as recited in claim 7, further comprising making ranked team data available to members of the teams.

9. A method as recited in claim 3, further comprising awarding additional bonus points to members who have exceeded their respective goals.

10. A method as recited in claim 1, further comprising determining a measure of goal completion for a member's fitness data.

11. A method as recited in claim 1, further comprising determining a team's goal completion by tabulating fitness data for members of the team.

12. A method as recited in claim 11, further comprising ranking teams based on respective goal completion.

13. A method as recited in claim 1, wherein the updating further comprises allowing a member to update his or her fitness data on a kiosk at a health club.

14. A method as recited in claim 1, wherein the teams comprise departments of a company.

15. A method as recited in claim 1, wherein the teams comprise different companies.

16. A method as recited in claim 1, further comprising allowing the members to grant or deny permission for other members of the member's team to view the member's fitness information.

17. A method as recited in claim 1, further comprising allowing the member to grant or deny permission to use the member's fitness data in aggregated data for the member's team.

18. A method, comprising:
inputting from a user a targeted exercise;
displaying a human character;
highlighting parts of the human character that are relevant to the targeted exercise;
allowing the user to click one of the highlighted parts; and
displaying a list of exercises relevant to the clicked part.

19. An apparatus, comprising:
a communication unit receiving fitness data for a plurality of teams;
a server connected to the communication unit aggregating the received fitness data by team, computing a ranking of the plurality of teams, and making a ranking of the plurality of teams available to the plurality of teams.

20. A computer readable storage medium storing a method to maintain fitness information, the storage medium controlling a computer by:
maintaining a plurality of teams, each team comprising a plurality of members;
updating fitness data for the members; and
tabulating tabulated fitness data based on the fitness data for the members of each time.
